(19) United States
(12) Patent Application Publication
(10) Pub. No.: US 2012/0173380 A1
(43) Pub. Date: Jul. 5, 2012

(54) Pay To Bid Auction System

(76) Inventor: Darin Mitchell Gould, Michigan City, IN (US)

(21) Appl. No.: 13/417,556

(22) Filed: Mar. 12, 2012

Related U.S. Application Data
(63) Continuation-in-part of application No. 12/832,048, filed on Jul. 7, 2010.

(51) Int. Cl. G06Q 30/08

(52) U.S. Cl. 705/26.3

(57) ABSTRACT

Methods and systems for conducting electronic auctions. Bidders purchase the chance to bid, the number of times bidding are used as a winning factor. Bidder who has the highest Personal Bid and earliest bid time is selected as winner. Alternatively, Bidder who spend Highest Credit Bid and earliest bid time is selected as winner. A timer is reset to provide a new target time by adding a set number of seconds to the remaining time each time a new bid is placed.

### REFERENCE TO RELATED APPLICATIONS

This is a continuation-in-part application of application Ser. No. 12/832,048 filed on Jul. 7, 2010

### DESCRIPTION OF RELATED ART

The present application relates to electronic auction system, and more particularly to an electronic auction system wherein users pay to place a bid, and incentives are given to early bidders and frequent bidders.

Note that the points discussed below may reflect the hindsight gained from the disclosed inventions, and are not necessarily admitted to be prior art.

Online auctions are becoming popular network-based electronic commerce and, providing a sensational and efficient way for buying, selling and negotiation between buyers and sellers of goods and services on the Internet. Traditionally sellers enjoy conducting business where there are many buyers and buyers enjoy conducting business where there are many choices. However, as the online auction industry has matured, the mass market approach for many sellers has been an effort with diminishing returns as auctions inherently lead buyers' main focus to price.

Current auctions conducted by service providers, such as eBay.com, only require sellers to pay a fee for setting up an account on the service provider's system, and for sellers listing their items for auction. Bidders are not required to pay fee to set up an account. Buyers login to place a bid, and when the date and time for ending the auction arrives, the highest price bidder becomes the winner and buys the item at the final price. Often a seller may not be able to make a profit if not enough bidders participate the auction.

It is estimated that there are over 1000 companies similar to eBay, Inc. that compete by offering a variety of auction-styled ecommerce environments that address a wide range of horizontal and vertical marketplaces. No systems have thought of providing incentives for buyers to participate an auction at early stage and to place bids more often.

### SUMMARY

The present application discloses new approaches to provide incentives for bidders to participate auctions early and to place more bids.

In one embodiment, an electronic auction system includes user database that auction participants are required to set up accounts by purchasing credits or bids. The system tracks an auction participants' bidding histories, accumulated numbers of biddings and accumulated credits spent. Computation servers are instructed to decide the winners according to designated special auction rules that provides incentives for bidders to participating bidding.

In one aspect, the auction winner is the bidder who placed the highest bidding price reached within the auction time frame.

In one aspect, the auction winner is the bidder who placed the most number of bids.

In one aspect, the auction winner is the bidder who has spent the most credits during the auction.

In one embodiment, non-winning bidders are allowed to recycle their purchased bids to use in next auction.

In one embodiment, free credits are provided as promotion to induce bidding.

In another embodiments, the price of a bid varies in accordance with certain rule to provide different level of incentives to participate in the auction early.

In another embodiment, alternative items are provided for various level of bidders.

The disclosed innovations, in various embodiments, provide one or more of at least the following advantages. However, not all of these advantages result from every one of the innovations disclosed, and this list of advantages does not limit the various claimed inventions.

The system prevents the auction from losing money if it ends early, before reaching a reserve price. It maintains an incentive even if the auction should end early by providing alternate credits for winners of auctions that end early.

It advances the auction toward a successful sale, even if the auction should end early. It creates an environment where bidders can use a variety of bidding strategies.

It allows auction thousands of items, worth millions of dollars, while maintaining very low final purchase price.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 schematically shows an example functional flow chart of an auction system in accordance with this application.

FIGS. 2-7 schematically show an example functional flow chart of “Bid Placed” module in accordance with this application.

FIGS. 8-9 schematically show an example functional flow chart of “Auction Ends” module in accordance with this application.

FIG. 10 schematically show an example functional flow chart of “Test Connection” module in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

This electronic network of “pay to bid” auction system combines several elements in a unique manner to facilitate holding auctions with very high values: up to hundreds of millions or even billions of dollars.

The system and method includes user database, central servers and displays system that displays the user interface. The system is instructed by installed software to perform various functions disclosed in this application.

The system or method may be performed in real time on a computer having application software installed to cause the computer to operate in accordance with the system or method. The computer system or method is comprised on a personal computer. The computer has memory to store the software and a processor to execute the system or method. The computer also has input means typical of a personal computer, such as a keyboard and a mouse.

The bidders will need to purchase bids before being able to place a bid. The basic function of the Pay to Bid Auction system is as follows:

When an auction begins, a timer will begin counting down to zero. Participants purchase bids and/or set up account for credits. When a user places a bid, the Common Bid will increase by some fixed amount, and the timer will be reset to a value established in the rules for the particular auction. If none places a bid, and the timer reaches zero, then the auction will end. The winners can then purchase the items, usually at a price related to the value of the Common Bid, as established in the rules for each auction. An auction could also end if it continues up to a specific time and date established in the rules for a particular auction.

The system combines three methods of determining winners. The rules of a particular auction may use one, two, or all three methods. Preferably, auctions will use the Common Bid method together with the Personal Bid method.

A) “Common Bid”: every time any user bids in a particular auction it will increase the common bid. The latest bidder becomes the highest bidder on the Common Bid List.

B) “Personal Bid”: the number of times a particular user has bid in a particular auction. Each time a user bids it will increase their “Personal Bid” in this particular auction.

Auction rules will convert the number of times participants bid into a monetary value, which represents their “Personal Bid” and the amount they will pay to purchase an item if they win an auction. Typically, participants' number of bids will simply be multiplied by some fractional or whole part of a penny.

For example: 29 bids×1 cent each=29: Their Personal Bid would be $0.29.

The High Personal Bid List is then determined: all participants would be ranked first in the order of the value of their Personal Bid. Then, for each particular value, participants would be ranked in the order in which they placed their bid. The High Personal Bid list would then be taken in order, beginning with the Bidder with the highest Personal Bid and earliest bid time, according to the number of winners set in the auction rules.

The bidder who has purchased the most bids will be the highest bidder on the Personal Bid List.

C) “Credit Bid”: Each time a user bids it will increase their “Credit Bid” in this particular auction. This is the total number of credits a bidder has spent while bidding on a particular auction. (If the cost to bid was always the same, then the highest “Personal Bid” and highest “Credit Bid” would be the same bidder. However, this system includes an option to increase cost to bid every time a bid is placed, so there could be different highest bidders when using both these methods together on the same auction.

Typically, the monetary value of participants' Credit Bids will simply be equal to the number of credits spent.

The High Credit Bid List is then determined. All participants would be ranked first in the order of the value of their Credit Bid. Then, for each particular value, participants would be ranked in the order in which they placed their bid. The High Credit Bid list would then be taken in order, beginning with the bidder with the highest Credit Bid and earliest bid time, according to the number of winners set in the auction rules.

The bidder who has spent the most credits on bids will be the highest bidder on the Credit Bid List.

The cost of a bid, aka “Cost to Bid” in the system, can change by a fixed value, for example, increase a fixed fractions of one cent each time a bid is placed. Each time a user bids, the cost to bid will then increase for the next person to place a bid, and so on, until the auction ends.

For instance, the Cost to Bid could increase: 1/10,000, 1/100,000. or 1/1,000,000 of one cent each time a bid is placed. The fractional amount could be as small as is deemed necessary to fit the needs of a particular auction.

The Cost to Bid could increase by fractional parts of a penny every time a bid is placed, or periodically.

For example, the first bid could cost 10 credits (10 cents). The Cost to Bid could increase one-ten-thousandth of a cent each time a bid is placed.

1st bid costs $0.10.0000;

2nd bid costs $0.10.0001;

30,000th costs$0.39.9999;

30,001^{st} costs $0.40.0000.

Or the first bid could cost $0.10 and the Cost to Bid could increase one cent every ten thousand bids.

1st to 10,000th bid cost $0.10 each;

10,001st to 20,000th bid cost $0.10 each.

The system could increase the Cost to Bid according to varying periods for a particular auction. The system could increase the Cost to Bid one cent each time an increasing number of bids have been placed.

First 10 bids cost $0.10 each;

Next 11 bids cost $0.11 each;

Next 12 bids cost $0.12 each.

The cost to bid could also stay the same throughout a particular auction.

In a particular auction, the rule can be set that the Common Bid can increase by fractional parts of a penny each time a bid is placed. The Common Bid can increase at a fixed rate or at an increasing or decreasing rate.

When a particular auction begins, the Common Bid could start at any amount and each time a user places a bid, the Common Bid would increase, for example, by a fixed fractional part of a penny. The fractional amount added could be as small as 1/1,000,000 of a penny, or even smaller as required for a particular auction with high total value. For example, the Common Bid could start at $0.10.0000 and add $0.00.0001 each time a bid is placed.

The Increase of Common Bid can be at changing rate. The rate at which the Common Bid increases could increase or decrease until a minimum or maximum rate of change is reached. The rate could change by a small amount each time a bid is placed, or periodically each time a certain number of bids have been placed. The change could begin with the first bid or it could begin changing once a certain Common Bid has been reached, such as the Reserve Price.

Auction participants are also encouraged to purchase credits. Credits will facilitate purchasing bids, the price of which may include fractional parts of a penny and as small as millionths, or even smaller as required for a particular auction.

The auction can use a second decimal to indicate fractional parts of credits, for example, $0.10.0009.

“Pay to Bid” electronic auction system also includes other features as follows:

1) Reserve Price: Auctions can have a reserve price. If a particular auction ends before the Common Bid reaches the reserve price, then the featured item will not be sold. Instead, winners will have the option to purchase items of lower value.

2) Alternate Item Value: If an auction has a reserve price, then a lower valued item will be offered at the start of the auction. As the Common Bid increases, the value of the alternate item will increase. The rate the alternate value item increase will be based on some percentage of income generated by the auction (example: 50%).

3) Auction Restart: If an auction ends early, items equal to a certain percent of the credits earned from the auction would be sold to the winners. The rest of the credits will be applied to reducing the Reserve Price and the Auction will Restart. An auction can restart as many times as required until the Common Bid Reaches the Reserve Price and the Featured Items are sold to the highest bidders.

4) FreeCredits: When auctions first begin, they can offer FreeCredits as an Alternate Value Item. FreeCredits can be spent just like normal Credits, except that they can only be spent on auctions after the Reserve Price has been met, if an auction has a Reserve Price. FreeCredits do not add a cost to an auction. So, if an auction ends early, the Reserve Price will still ensure the auction generates an appropriate level of income to cover the entire cost of all items sold.

5) Winner Option to decline Alternate Value Item: When an auction ends early, before the Reserve Price is met, the rules could allow winners to decline to accept the Alternate Value Item. If a winner accepts the Item, then they will lose the Personal Bids they have accumulated and lose their place on the High Personal Bid List. So, by declining the Alternate Item, they could benefit by keeping their place on the High Personal Bid List. Optionally, the auction could then offer the item to the next ranking participant who did not already win an item.

Winners may need to decline the item before the auction restarts.

6) Multiple Item Auctions, Different Items for each Winning Method, and Winning Multiple Items in an Auction. Multiple Items can be offered for sale in an auction. An auction could have multiple winners for one or more Methods used to determine winners.

For instance, an auction could offer ten items for sale. Five items could be sold to the five highest bidders on the Common Bid List, and five items could be sold to the five highest bidders on the Personal Bid List.

A particular auction may offer different items, different numbers of items, and different valued items for sale via each Method. Furthermore, an auction could allow bidders to win more than one items. First, a single bidder could be on the highest bidder list for two methods, such as the Common Bid List, and the Personal Bid list. In this case they could win two items in a particular auction.

For any particular auction, the rules could either allow or disallow the possibility to win an auction by more than one method.

Second, a single bidder could be on the Common Bid List multiple times. The number of items a single bidder could win in such a situation would be determined in the rules for each particular auction.

7) Reusable Personal Bids (Recycled Personal Bids) and Refunded Credits (FreeCredits). Rules, for a particular auction, may allow participants who do not win to reuse Personal Bids and/or Credits, which they bought/spent on this auction. In contrast, all winners will not be refunded any Personal Bids or Credits.

For Recycled Personal Bids, when a bidder does not win a particular auction, then after the auction has closed, the rules of the auction may allow the bidder to reuse the Personal Bids they purchased in this auction in a future auction. For each Personal Bid the bidder purchased in the auction, they would receive one Recycled Personal Bid they could use in another auction.

The rules of each auction could either allow or disallow the use of Recycled Personal Bids. If an auction allows Recycled Personal Bids, each time a bidder purchases a bid, the bidder would be able to apply Recycled Personal Bids in some ratio determined by the rules of this particular auction.

For example, when the bidder places a bid, they could also choose to apply 1, 2, 5 or some other number of Recycled Personal Bids, thus increasing their total Personal Bid for this auction.

For Refunded Credits, the rules of an auction could allow credits of participants who were not winners to be refunded to them as FreeCredits. These FreeCredits could then be reused on other auctions which allow the use of FreeCredits.

8) Sale of more than one Personal Bid in a single transaction: the rules of a particular auction could allow bidders to purchase more than one Personal Bid at a time. This would be useful to bidders who want to get a higher position on the Personal Bid List.

This type of transaction would increase the Common Bid as if just a single bid were purchased, but would increase the bidder's Personal Bid by an amount equal to the number of bids they purchase.

9) Automatic Bidding System & Sniping Option: Participants would have an options to set an automatic bidding system to bid on their behalf. The user could also set up the AutoBid to attempt to snipe the auction by setting it to bid only when an auction is approaching the final time and date when the auction will end.

Users have the following options: A) Time to start bidding; B) Maximum Credits to spend; C) The number of bids (from other participants) to wait before sending another bid. This option may useful in auctions that have more than one item for auction, and each participant could win more than one item. This option could be used to attempt to increase a participants chance to win. Instead of setting the autobidder to bid as soon as another participant places a bid, a user could set the autobidder to wait every 10th bid in an auction in which 10 items will be sold to the top 10 high bidders on the Common Bid List.

The auction software could potentially need to handle thousands of bids per second. To handle bids as efficiently as possible, several versions of the software will be run on one or more servers to handle auctions using the same or similar sets of rules. Each version of the software will exclude portions of the code, which are unnecessary for auctions with particular rules.

The auction network may utilize separate version of software to manage the database and run the auction and bidding system. They could run on separate servers. This is to ensure the software runs as efficiently as possible.

In order to attempt to prevent an auction from ending early due to an Internet connection problem, the system will use one or more additional servers set up on different Internet backbones and send encrypted messages between them in order to test the Internet connection before an auction closes. In case there is a delay, the auctions could be paused until the connection problem has been resolved.

The “Pay to Bid” electronic auction system handles various currencies, for simplicity, the US Dollar is used in the examples.

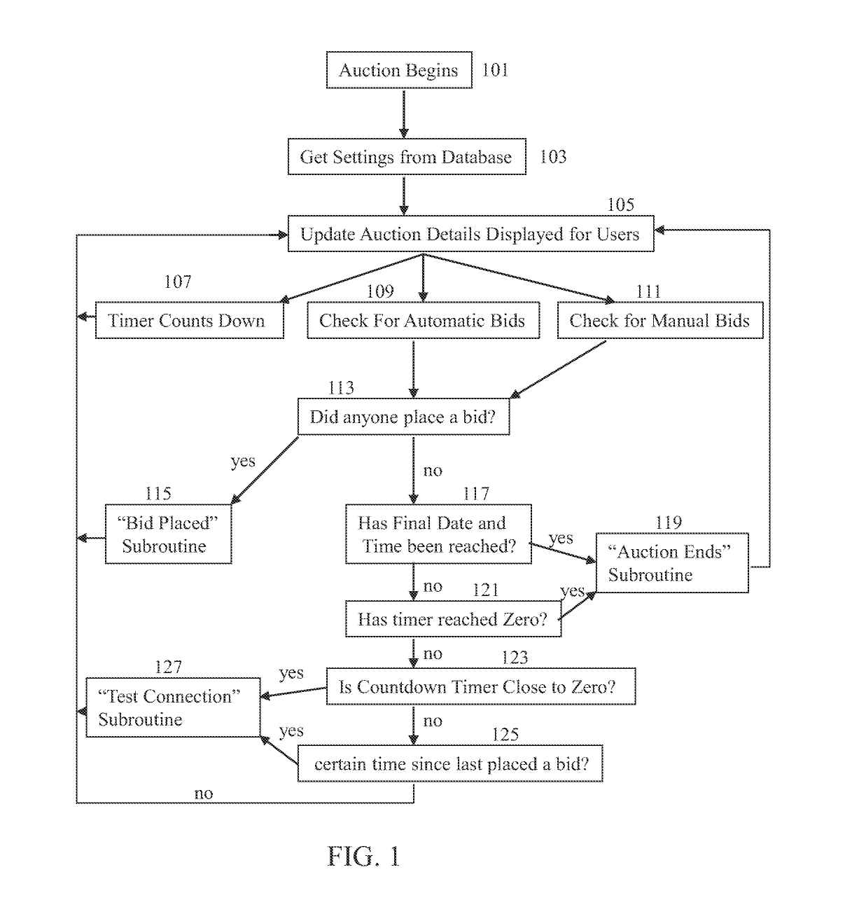

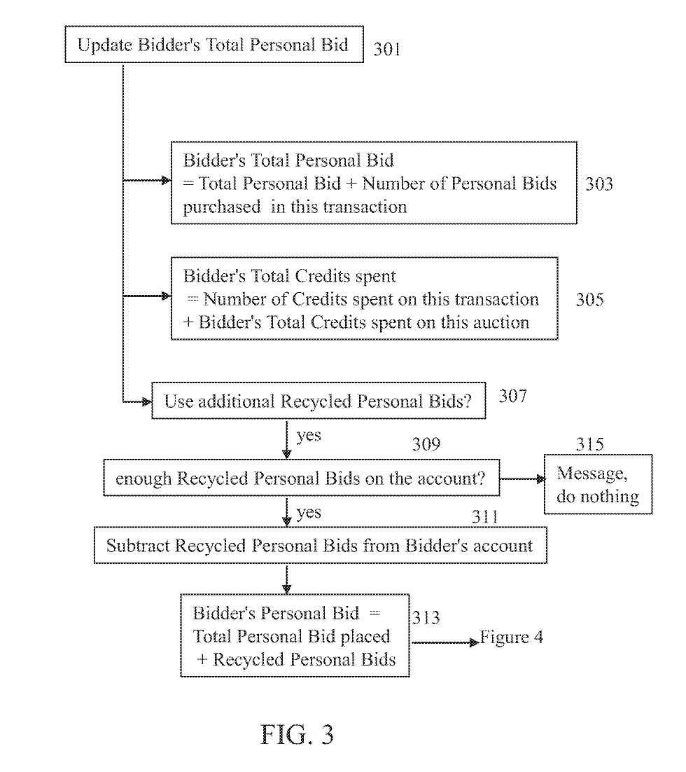

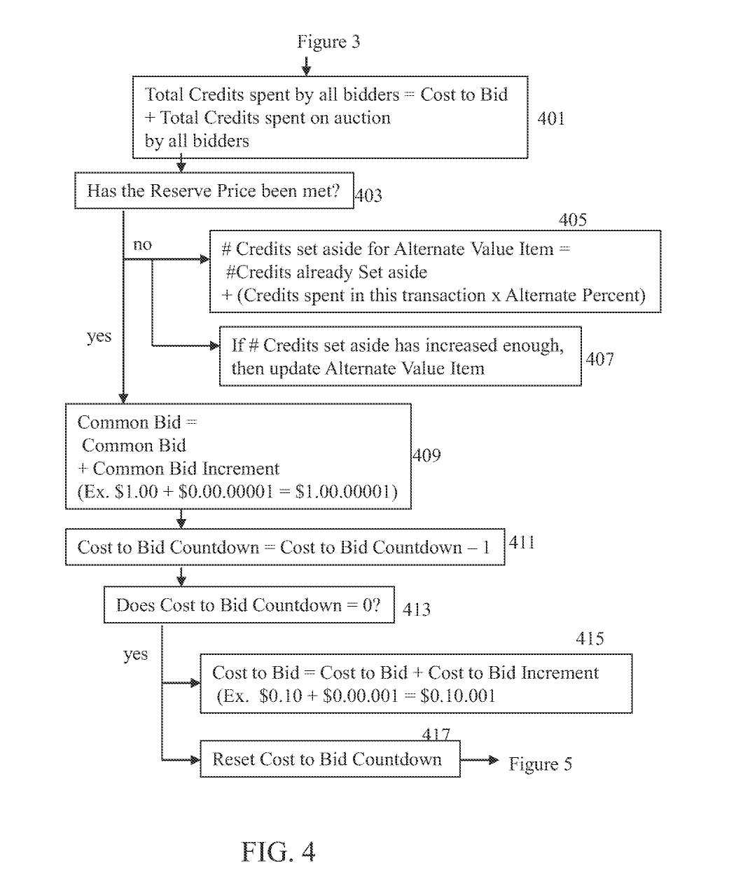

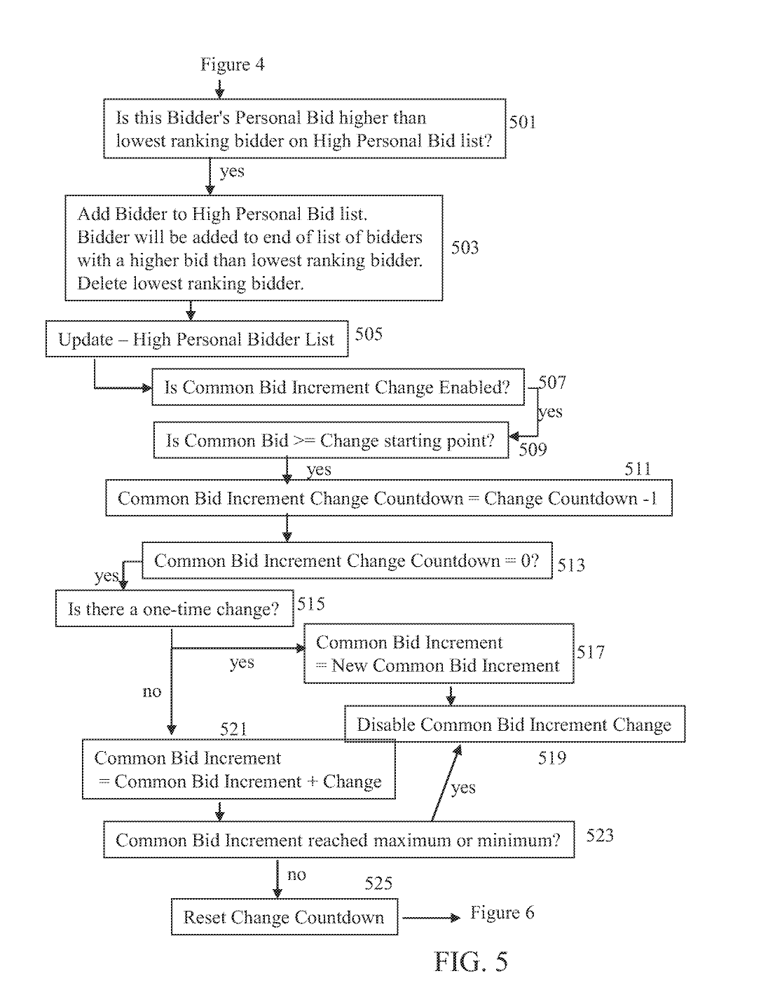

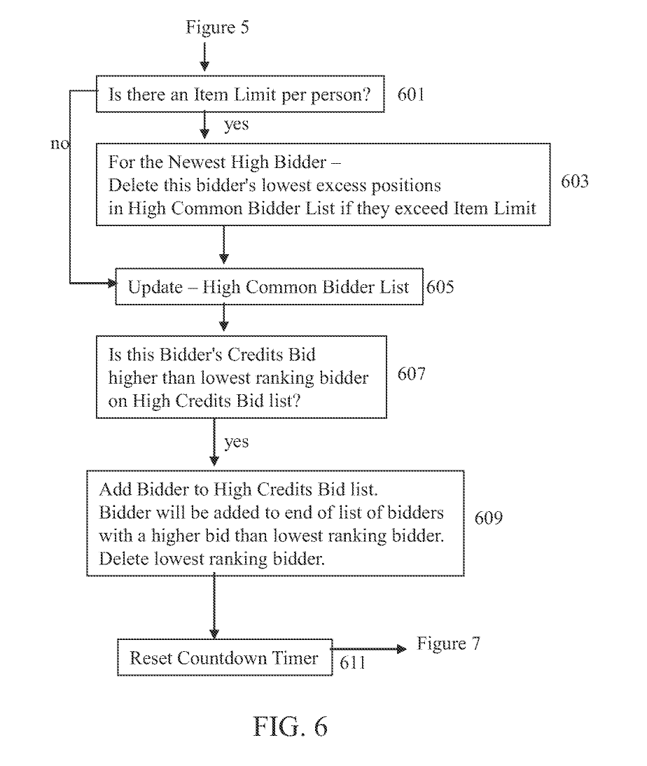

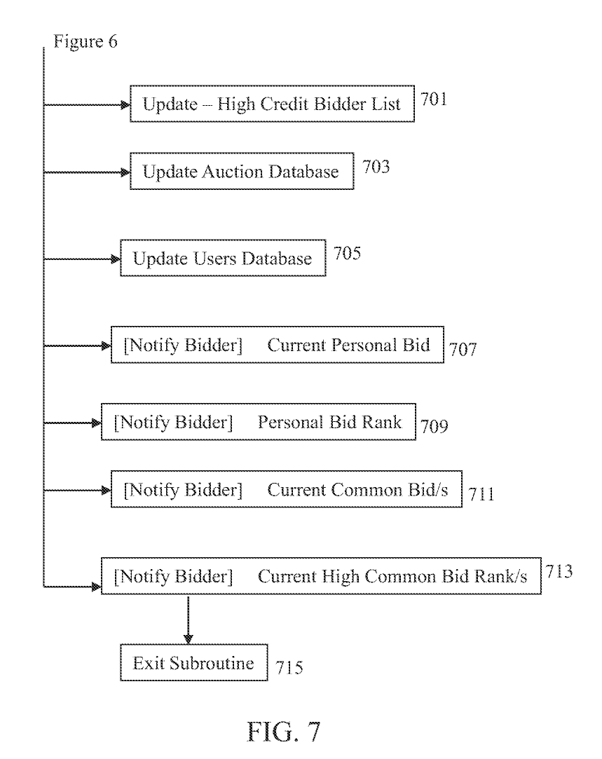

FIGS. 1 to 10 show an example logic flow chart of a “Pay to Bid” auction embodiment.

In reference to FIG. 1, the example embodiment includes a database that tracks auction participants' bidding history and account settings, shown in step 103. It has user interface for display updated auction information, as shown in step 105. It has timer module, as shown in step 107, “Bid Placed subroutine” module as shown in step 115, and “Auction Ends subroutine” module as shown in step 119, and “Test Connection subroutine” as shown in step 127.

Main properties of the system include: 1) Bids; 2) Timer; 3) Increment; 4) Price.

‘Bids’ may be sold at various rates at steps 101-105.

Quantity discounts may be offered, for example, $100 for 100 “Bids”, free bids for signing up for a new account OR for referring new customers may also be offered.

For each bid, Timer may be set to any suitable time for a particular auction, for example, 20 seconds or 3 minutes, at step 107. The Timer is reset every time a bid is placed and begins counting down again.

If none else bids and the timer reaches zero then the highest bidder has won, at step 117 and step 121.

Every time a bid is placed at step 109, 111 and 113, the Auction Price increases an increment in step 115. Auction Price is the current price of the item being auctioned. The Price may be set to begin at any relevant value by the seller. Every time a user places a bid the Price increases by the Increment.

Users can setup “BidBuddies” OR “BidButlers” to bid automatically on their behalf. To use a BidBuddy they set 1) amount they wish to begin bidding; 2) amount they wish to stop bidding; 3) maximum number of bids they want to use

Every timer a user places a Bid the Timer resets and begins counting back down to zero. Whenever the timer reaches zero the highest bidder wins. The highest bidder may be determined according to if it is the Highest Personal Bidder or the Highest Credit Spender. The winner the pays the final Common Bidding Price to buy the item (most common)—OR they pay a Fixed amount—For example $100—OR they get a full discount for the item.

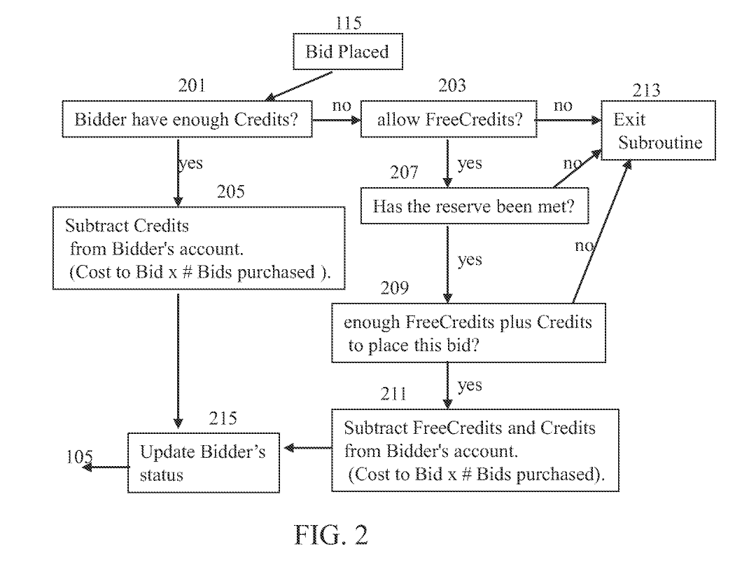

FIGS. 2-7 show a logic flow of the process to keep track of each bidder's bidding history and the accumulation of Personal Bid, and determination of High Common Bid list, High Personal Bid list, and High Credit Bid list, and updating the databases.

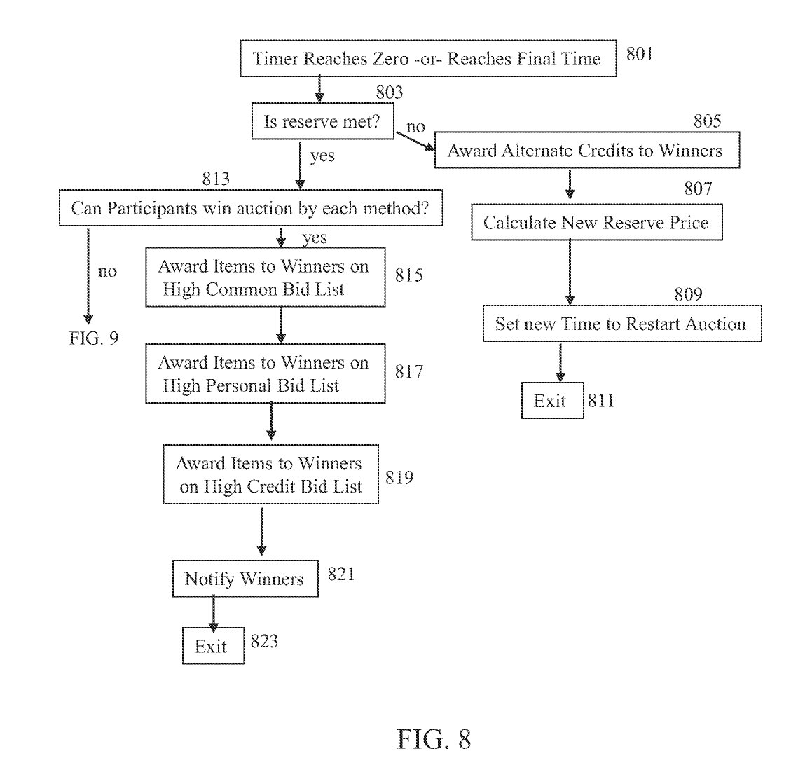

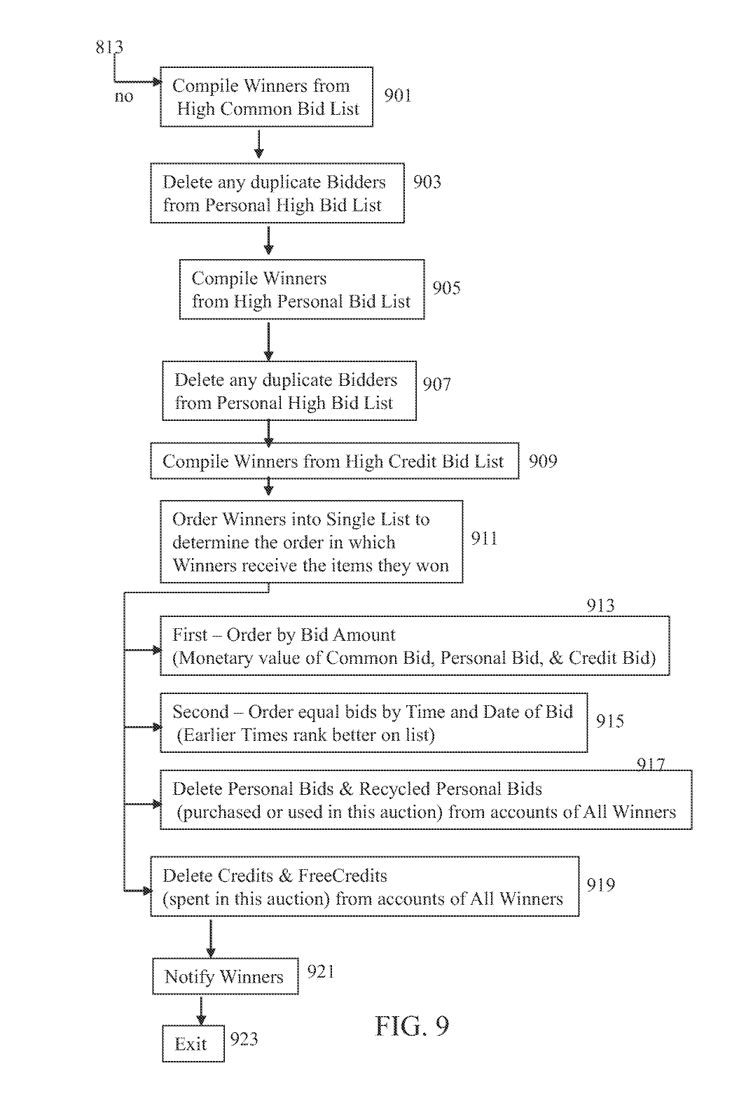

FIGS. 8 and 9 the logic flow of the process in determining the winner according to different auctions rules.

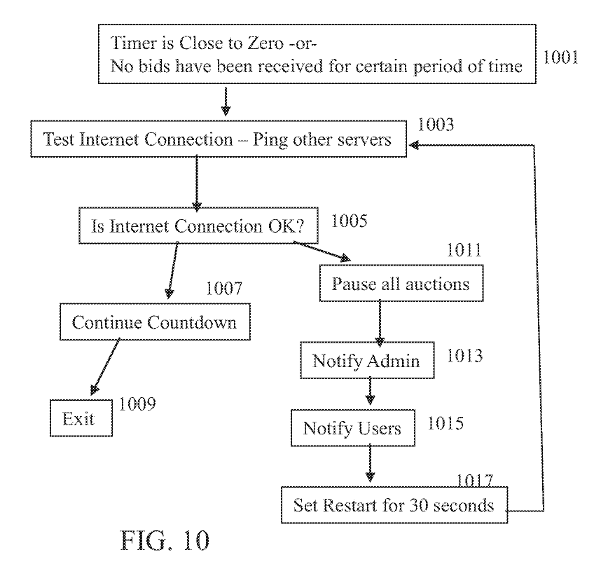

FIG. 10 illustrates the steps for test connections periodically to make sure unstable internet connections are remedied in terms of auction time counting down.

Alternate Method to generate High Bid List for Personal Bid and Credit Bid.—First Bid Only.
The rules for a particular auction could add only first bid, at a particular amount, to the High Personal Bid List and/or High Credit Bid List.

Example: If three participants have each purchased thirty bids, only the first bidder to have purchased thirty bids would be placed on the High Personal Bid List. The other two bidders would need to purchase more bids until they have purchased the first bid for a higher unique amount, such as thirty-one, or thirty-two.
The rules could also allow a bidder to be added to the High Personal Bid List or High Credit Bid List more than once.

With the normal method, each bidder could only be on either High Bid List just once, but in this case, they could be added to each list more than once by placing the first bid for more than one unique amount. The rules for each particular auction would define the limit as to how many times a bidder could be added on the list.
Example: If a participant places the first bid for thirty Personal Bids, then the first bid for thirty-one Personal Bids, they could be placed on the High Personal Bid List twice.
If a bidder has made the High Bid List by making the first bid for a certain amount, the rules would normally allow the bidder to continue to purchase bids without losing their position on the list. The bidder may wish to do this to make it easier for an attempt to purchase the first bid at a higher amount in case their lower High Bid has been outbid enough times for it to fall off the High Bid List.

Group Bidding

Rules for certain auction could allow multiple bidders to cooperate to bid on behalf of a single person, or entity, such as a school or fire department.

Individual users could either bid directly or contribute credits, which would then be managed by an automatic bidder.

The other entity, such as a school, would not need to be a registered user. One user could simply register the name and city of the entity along with other relevant information.

Example: Users could cooperate to bid on an auction to win items for a particular school, such as computers, or playground equipment.
For some auctions, rules could also allow users to attempt to attract other users to bid on their own behalf.

Example: Students could attempt to convince other users to bid on their behalf for a computer or scholarship.

Double-Bid Auction System. A single transaction places bids on two or more auctions at the same time.
When a bid is placed on one auction, a bid is also automatically placed in one or more other auctions.
For purposes of this explanation, these auctions will be named Double-Bid Auctions and Bonus Auctions. When a bid on one auction also causes a bid to be placed automatically on another auction, then these auctions are related to one another. Here, they will called ‘related’ or in a ‘System.’
System: All the Double-Bid Auctions and Bonus Auctions, which are related to one another.

In a System, all settings for each Double-Bid Auction and each Bonus Auction could be unique, including: the item for sale; the number of items sale; the number of items each participant could win; whether there is a reserve price; the reserve price; starting cost to bid; starting price; amount added to the common bid each time a bid is placed; amount added to the cost to bid each time a bid is placed; etc.
To help keep the System simple for the participants to understand and easy to compare each auction, certain settings would normally be the same for all auctions in a System, such as: the amounts added to the cost to bid each time a bid is placed; and the amount added to the Common Bid each time a bid is placed.
Also, the starting Cost to Bid for each Double-Bid Auction would normally be the same.
To keep it fair for all participants, each Double-Bid Auction and Bonus Auction, which will be part of a system, will be announced before the start of any single auction in the system. In other words, no new auction would not be announced after any single auction started. Normally, each related auction would also begin at the same time (all Double-Bid Auctions and Bonus Auction(s).
   The starting Cost to Bid of the Bonus Auction would always be equal to or higher than each of the starting Costs to Bid for each Double-Bid Auction.
Double-Bid Auction: Each time a participant bids in a Double-Bid Auction, another bid will automatically be placed in each related Bonus Auction.

Normally, there would be more than one Double-Bid Auction in a System.

There could be one or more Double Bid Auctions.
Bonus Auction: Participants could also bid on the Bonus Auction directly. The Bonus Auction could continue even after all related Double-Bid Acutions have ended.

A Bonus Auction could have multiple items.

Normally, there would be just one Bonus Auctions in a System, but there could be more.
If there are more than one Bonus Auctions in a System, then each Bonus Auction could have different items and/or different numbers of items.

Normally, the value of each item in the Bonus Auction would be higher than the value of any of the items in the Double-Bid Auctions, but the value could also be less than one or more of the Double-Bid Auctions.

Normally, Bonus Auctions would not award Free Credits or Recycled Personal Bids for participants who do not win, but the opposite would be optional.

In an embodiment of the invention:

1) When a bid is placed, rather than resetting the timer to a fixed number of seconds, as in ordinary pay to bid auctions, the auction could use a Target Time. Whenever a new bid is placed, a certain number of seconds can be added to the remaining time. The number added could range from 0 to any higher integer, depending on the settings of the auction. The number of seconds added can vary depending on whether the number of seconds remaining is higher, lower or equal to a target time. For example, the target time could be 30 seconds. If the remaining time is less than 30 seconds, then 15 seconds could be added to the timer. If the remaining time is equal to or greater than 30 seconds, then 0 seconds could be added to the timer.

There can be one or more Target Times. For example, the target times could be 30 seconds and 120 seconds. If the remaining time is less than or equal to 30 seconds, then 15 seconds could be added. If the time remaining is less than or equal to 120, then 10 seconds could be added. If more than 120 seconds, 0 seconds could be added.

The amount of time added to the clock could also change in relation to the number of seconds that have passed since the previous bid. For instance, in an amount equal to a multiple of the time since the last bid. The multiple could be any integer or fraction of integers, including 1.

For example, if the multiple is 2 and the time since the previous bid is 12 seconds, then 24 seconds will be added to the clock.

The methods and formula used to calculate the time added could include various combinations of the methods described above, such as varying in relation to a target time as well as varying in relation to the time since the previous bid.

The number of seconds added to the timer, the Target Time/s, and other methods described here can all change when certain events occur or when certain conditions are met, such as when the Common Bid reaches the reserve price or when the timer has dropped to a certain number of seconds for the first time.

The above methods of managing the timer will provide benefits to both the Participants and Business by allowing the timer to center around a higher number during frequent bidding periods. Besides other benefits, this will allow Participants to judge the current level of bidding activity and frequency.

2) Composite Bid: The composite bid adds the Common bid to a Participant's Personal bid or some multiple of their Personal bid.

Composite bid=Common bid+Participant's Personal bid

or

Composite bid=Common bid+Participant's total number of bids times some fraction of a cent

The Composite Bid does not need to use the same valuation as the Personal Bid

For Example: Each of a Participant's bids could be valued at 1/100 cent to calculate their Personal bid, while each of Participant's bids could be valued at 1/10 cent to calculate the Composite bid,

or vice versa.
(For simplicity, in the examples we will assume the valuations are the same.)

### For Example:

In a particular auction, the Common bid increases 1 cent each time someone bids and the Personal bid increases 1/10 cent each time someone bids. If the Common bid in this particular auction is currently $2.00:
1) A participant who has not bid previously (Personal bid is $0.00.0) places a bid. The Common bid increases to $2.01. Their Personal bid increases to $0.00.1. Their Composite bid is $2.01.1.
2) Another participant with a personal bid of $0.02.0 places a bid. The Common bid increases from $2.01 to $2.02. Their Personal bid increases to $0.02.1. Their Composite bid is $2.04.1.

The Composite bid is particular to each participant, similar to the Personal bid.

When a participant places a bid, it only increases their own Composite bid. It does not change or effect the toval value of any other participant's Composite bid.

Composite bids will have all the options of other types of bids.

The ordering of Composite bid High bidder list is the same as Personal bids and Common bids.

In case of equal Composite bids, the earliest bid will rank highest.

When a bid is placed, the value of the Composite bid will be calculated after the Common bid and Personal bid.

As described earlier, if an auction uses more than one bidding method, including Composite bids to determine winners, then a certain number of items would be awarded to the Highest Composite bidder/s.

The Composite bid adds significant value to a pay to bid auction because: It encourages both early bidding as well as continued bidding.

It will maintain a competitive auction when one participant has gained an advantage by purchasing a high number of total bids at lower prices earlier in the auction. Such a participant must continue to watch the auction and to continue to bid since they can still be outbid by a participant with fewer total bids.

Composite bids can allow an auction to have a separate way for participants to compete using their Spent bids so that participants without any spent bids and who are only buying new bids will not compete directly against participants who are using Spent bids.

3) Minimum Bid Frequency—In a typical pay to bid auction, the minimum bid frequency is always fixed at 1, meaning a participant can bid again once 1 bid has been placed by another participant. A participant cannot place a bid immediately after their own bid. However, in auctions with more than a single item for sale, it may be good for competition to have a higher minimum bid frequency. The minimum bid frequency could range from 0 to any integer above 1.
Ex. Each Participant must wait 100 bids before bidding again.

The minimum bid frequency could change when a certain condition or conditions in an auction have been met, such as reaching the reserve price. For example, the minimum bid frequency could change from 1 to 100 once the reserve has been met.

4) When an auction ends before reaching the reserve price, credits set aside for alternate items could be held and the alternate items sold to the next group of auction winners after the auction restarts and ends again. This will allow the number of alternate items for sale to be stated in advance of the restart of the auction.

5) Spent Credits can be used to purchase discounts on items in an online store. Each item for sale in the store will have a maximum discount amount which can be purchased with spent credits. The maximum discount could be as high as 100%. For instance, if an auction helps raise money to build a $20 billion wind turbine farm, then participants could use their spent credits to purchase electricity at a 100% discount. If an auction helps build a new $100 million college, then participants could use their spent credits to purchase courses at a 100% discount.

There are several important benefits of these discounts. This method of multiple item pay to bid auctions can be utilized to benefit communities worldwide by encouraging large-scale investment of billions of dollars or even trillions of dollars in new technologies, which could help communities as well as entire nations reduce carbon emissions, become energy independent, support better education, better healthcare, and support small businesses. Allowing participants to utilise spent bids to purchase discounts on other items will ensure that participants gain value for their investment. This will encourage a wider number of individuals and businesses to support the auctions and investments in new technologies, such as solar energy, wind energy, and electric vehicles. Therefore, the goal of offering discounts for spent credits is to broaden acceptance and support of this type of auction and make this entire method of pay to bid auction more sustainable and in turn benefit the entire global community.

6) A new Double-Bid Auction can begin when a certain event occurs or depending on certain conditions in other ongoing Double-Bid Auctions. Such conditions could be any combinations of the types of conditions explained in this and other parts of this method of conducting multi-item pay to bid auctions. Example A) A new Double-Bid Auction could begin as soon as the price in another Double-Bid auction reaches the reserve. Example B) A new Double-Bid Auction could begin when another Double-Bid Auction pauses or ends.

When a large quantity of an item X is to be sold in an Auction System, the items X could be sold in smaller quantities of one or more until the total number of items X has been sold.

For Example: In an Auction System, if 10,000 Electric Vehicles will be auctioned in double-bid auctions, then instead of selling them all in a single double-bid auction, the Electric Vehicles could be sold 100 at a time until they have all been sold.

The number of items sold in a new double-bid auction could increase or decrease according to various conditions. This could be in order to maintain an inventory of items until certain conditions are met, such as when the Bonus Auction has reached the reserve price. Or, it could be to sell off all remaining items for sale in double-bid auctions once the reserve has been met in the Bonus Auction.

Example A) The Ratio of the number of items X remaining to the total number of credits spent in an Auction System. If the percentage of the number of items X that have been sold 60% while the number of credits earned is only 30% of the number required to break even, then the number of items X which are sold in the next double-bid auction could decrease from 100 to 10. Or vice versa, etc. Example B) The Ratio of the numbers of each item remaining to all other numbers of items remaining. If one particular item X has sold at a faster or slower pace than others, the number of items X in the next subsequent auction can be decreased or increased to attempt to match the pace of sales for other items. Example C) The Ratio of the number of items remaining to reserve price of primary auction. If the reserve price has been met in the Bonus Auction but more than 50% of 1,000 of item X still remain, then the number of item X sold in the next double-bid auction could increase from 100 to 500 in order to liquidate the remaining inventory.

Normally, the software will attempt to keep the number of active double-bid auctions within a certain Minimum and Maximum. Therefore, a new double-bid auction will not begin if the number of auctions currently running is equal to or higher than a maximum number.

Normally, it will be desirable to run only one auction featuring a certain item X at a time. So, it will be better to start a new double-bid auction with an item Y which is not currently being auctioned. It will also be best to attempt to auction off all types of items at a somewhat similar rate.

Therefore, the software will normally follow a procedure similar to the following: When selecting which item to auction in a new double-bid auction, the software will begin by selecting the item with the highest number remaining for sale. If this item is already in an auction (eaither paused or live), then it will select the item with the next highest remaining number, etc. If, after checking all remaining types of items, each item is already in an auction, then it will select the item with the highest number available to begin the next double-bid auction.

The purpose and benefit of the above innovations is to maintain a minimum number of active Double-Bid Auctions until each Bonus Auction and/or the auction System has reached profitability. This will help minimize the chance of pausing the Bonus Auction because bidding has ended before the reserve has been met by attempting to maintain a constant rate of bidding on each Bonus auction. This will benefit Participants as well as the Business.

7) It is possible to have two separate high bid lists for each type of bid in a single auction.

In this case, the first would only allow new bids (excluding spent bids) and the other allows spent bids.

For example: an auction could have two Composite Bid high bid lists. The first would not allow the use of spent bids; the second would allow the use of spent bids.

Both high bid lists would be allotted a certain number of items for sale in the auction.

Both high bid lists would be handled in the same usual ways in all other aspects.

8) Instant Bids

Instant Bids are bids that can only be won in a Double-Bid auction. When a Double-Bid auction for Instant Bids ends, the Instant Bids will be placed on behalf of the winner in a Bonus auction. The placing of the Instant Bids will normally follow all the rules of the Bonus auction, except that the Instant bids will be placed on behalf of the winner as if the winner has two accounts bidding for the benefit of their own account. The main benefit of Instant Bids for a winner is that this will allow them to double the frequency of their bidding, especially when their is a limit on bid frequency.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A computer implemented system of using a first computer that performs transaction steps which communicates over the internet to a second computer for an electronic auction system comprising
an electronic server that runs an auction software and conducts auction process electronically wherein a chance-to-bid in an auction is valued and placed for purchase, and an auction participant needs to purchase said Bid to place a bid in said auction, and winning of said auction is determined by an auction rule;
an electronic device electronically connected with said server, and installed with a database which keeps track of said participant's bidding history in an account of said participant;
a display device electronically connected with said server, displaying information from said participant's account and said auction; and
a timer is reset to provide a new target time by adding a set number of seconds to the remaining time each time a new bid is placed.

2. The electronic auction system of claim 1, wherein the number of seconds added to the target time can range from zero to any higher integer.

3. The electronic auction system of claim 2 wherein the number of seconds added can vary depending on whether the number of seconds remaining is higher, lower or equal to a target time.

4. The electronic auction system of claim 3 wherein here are two or more target times.

5. The electronic auction system of claim 3 wherein the time added to the clock can also change in relation to the number of seconds that have passes since the previous bid.

6. The electronic auction of claim 3 wherein the time added to the clock can vary in relation to a target time as well as vary in relation to the time since the previous bid.

7. The electronic auction of claim 3 wherein the time added to the clock or the target time when a common bid reaches the reserve price or when the timer has dropped to a certain number of seconds for the first time.

8. The electronic auction of claim 1 wherein the participant's bidding history includes personal bid, wherein personal bid is the total money cost in the auction for purchasing bid in each round of bidding and a composite bid is obtained by adding the common bid to a participant's personal bid or some multiple of the personal bid.

9. The electronic auction of claim 8 wherein the multiple of the personal bid is a fraction of a cent.

10. The electronic auction of claim 1 wherein each participant is subject to a minimum bid frequency wherein a participant cannot place a bid immediately after their own bid but must wait until there are at least two bids by others before bidding again.

11. The electronic auction of claim 10 wherein the minimum bid frequency can change from 1 to 100 when the reserve price has been reached.

12. The electronic auction of claim 11 wherein the auction is a double bid auction which includes multiple items and multiple auction rules are used to determine winners of the items; wherein a new double bid auction can begin when a certain event occurs or at least one certain condition occur in another ongoing double bid auction.

13. The electronic auction of claim 12 wherein the at least one certain condition that occurs is another ongoing double bid auction is when the other double bid auction pauses or ends.
